(19) United States
(12) Patent Application Publication
(10) Pub. No.: US 2010/0110455 A1
(43) Pub. Date: May 6, 2010

(54) LANGUAGE BASED COLOR SELECTION METHOD

(75) Inventor: Geoffrey J. Woolfe, Wahroonga (AU)

Correspondence Address: Ronald F. Chapuran;Patent Documentation Center, Xerox Corporation, 100 Clinton Avenue South, Xerox Square, 20th floor, Rochester, NY, 14644, US

(73) Assignee: XEROX CORPORATION, Norwalk, CT (US)

(21) Appl. No.: 12/262,204

(22) Filed: Oct. 31, 2008

(51) Int. Cl. H04N 1/60

(52) U.S. Cl. 358/1.9

(57) ABSTRACT

A method of color selection is described including a component to parse a natural language color specification into a set of colloquial color names and a set of flags to indicate whether a color name is to be included or excluded from the color selection. Components are also included to find the best matches of colloquial color names in a library of colloquial color names and map the best matches to one or more standard colors in a library of standard colors. A transform building component uses the standard colors names and the flags to create a mathematical selection transform, typically in the form of a multi-dimensional lookup table. If necessary, another component converts arbitrary sets of test color coordinates into color encoding identical to that used for the standard colors to produce a color selection.

In the field of color image or profile editing it is common to want to modify a certain range of colors while leaving other colors unchanged. The selection of the target colors is a difficult problem that has been addressed in a number of ways in the past. Existing methods include:
1. Magic wand type tools such as implemented in Adobe Photoshop. In these types of tools a user selects a pixel in an image and a tolerance parameter. The tolerance can be thought of as a color distance metric.

The tool selects all colors within the tolerance distance of the selected pixel. The selection can be limited to either contiguous or non-contiguous pixels within an image. The selection can be increased by holding down the shift key and clicking on another pixel in the image. The selection can be subtracted from by holding down the alt-key and clicking on a pixel in the image. This type of color selection tool is limited to working with images.
2. Adobe Photoshop also offers a selection based on color range. In this tool the user is offered a simple menu consisting of the choices of red, green, blue, cyan, magenta, yellow, highlights, midtones and shadows. These selections are based on a simplistic categorization based on the color values of the pixels. Again, this technique only applies to images although one could envisage it being applied to abstract collections of color data—such as color management profile data with relatively minor changes.
3. In U.S. Pat. No. 6,894,806, Woolfe et. al. have proposed and implemented a method of color selection in which color regions are chosen based on an anisotropic metaphorical model of magnetism. Each region is specified by a central point and an anisotropic distribution function around the center point. The selection is “fuzzy” in that the distribution functions are continuous and asymptotically decay to a limiting (usually 0) value.
4. Various other methods of color selection can be found which are generally similar in nature to those described above.

A significant shortcoming of all these methods is that the color selection is not constrained or influenced by the perceptual boundaries that exist between colors. These perceptual boundaries are reflected in the color naming behavior of humans. An additional problem is that most of the existing methods rely to some extent on the user having a technical understanding of the color encoding in which the colors are represented.

The present invention addresses these shortcomings by providing a color selection method or algorithm that is very easy to use, respects natural color naming boundaries and is extremely powerful. The method only requires a user to be able to provide a verbal description of the color selection. No technical color knowledge is required. Also, the method can be easily applied to all types of color data—in the form of an image or simply a collection of color data. Another major advantage is that the selection boundaries, as defined in the transform color encoding, follow perceptual color naming boundaries that reflect the way human observers mentally categorize colors. This provides a natural and well behaved selection compared to the results obtained using arbitrary geometrical boundaries around a color center.

This invention provides a specific implementation of color selection as described in pending application U.S. Ser. No. 11/479,484 filed by Geoffrey J. Woolfe, titled “Natural Language Color Communication and System Interface,” Publication No. 20080007749, published Jan. 10, 2008 (Attorney File No. 20051444), this application being assigned to the same assignee as the present invention, and the subject matter of the specification of this application being incorporated herein.

This invention enables color-naïve users to quickly and easily make a sophisticated selection of a subset of colors within a larger set of colors. Such a set of colors could be in the form of an image, a color management profile or even a (virtual) collection of color samples or swatches. The user simply requests the color selection using a natural language specification or description. Examples of such natural language descriptions include the phrases:

a. “Reds and greens”

b. “Pale greens”

c. “Greens, but not dark greens”

d. “Reds, oranges and bright yellows, but not scarlet”.

These phrases illustrate a number of characteristics of the invention. These characteristics include:
1. The ability to select a union of multiple color regions that are either contiguous (e.g., reds, oranges) or non-contiguous (e.g., reds and greens) regions of color.
2. The ability to eliminate or omit a sub region from a more general selection (e.g., greens but not dark greens and reds and oranges and bright yellows but not scarlet).
3. The ability to use a qualifier to a more basic color name (pale greens and bright yellows).
4. The ability to use colloquial or common color names (e.g., scarlet).

The natural language color description is translated into a mathematical transform that makes the selection. The mathematical transform returns either a Boolean result indicating whether a color is in or outside, the selection or it returns a continuous result indicating the probability that the color is likely to be inside the selection. In the latter case the selection transform might return a value of 1 if a color is definitely in the selection and a value of 0 if the color is definitely outside the selection. A returned value of 0.5 would indicate that there is a 50% probability that a color is in the selection. The construction and operation of the selection transform is invisible to the user. In use, the selection transform would be applied to a set of colors to return only the selected colors. If the set of colors is an image then the selection would likely be returned in the form of a mask—either binary or continuous. If the set of colors is in the form of a list of colors then the selection could be returned either as a list of indices into the list or a set of probabilities representing the probability that each color in the set is in the selection. If the set of colors is a collection of color samples or swatches then the selector could return a set of descriptors (e.g., names or numerical color coordinates) of the samples or swatches that are in the selection.

The invention, in general, includes the following functional components:
1. A component to parse a natural language color specification into a set of colloquial color names and a set of flags (indicators) to indicate whether a color name is to be included or excluded from the color selection.
2. A string matching component that, for each colloquial color name identified in component 1, finds the best matching colloquial color name in a library of colloquial color names.
3. A mapping component that maps each matching colloquial color name identified in component 2 to one or more standard color names in a second library of color names.
4. A transform building component that uses the standard color names (from component 3) and their numerical coordinates in a color encoding, together with the flags from component 1, to create a mathematical selection transform, typically in the form of a multi-dimensional lookup table.
5. A component that can transform an arbitrary set of test color coordinates into a color encoding identical to that used for the standard colors referenced in components 3 and 4.
6. A component that can map the resulting coordinates from component 5 through the selection transform created by component 4 to produce a result that indicates either:
   a. which of the test colors are in the selection, or
   b. the probability that each of the test colors is in the selection.

A typical exemplary embodiment of these components will be described in detail, with reference to the following figures.

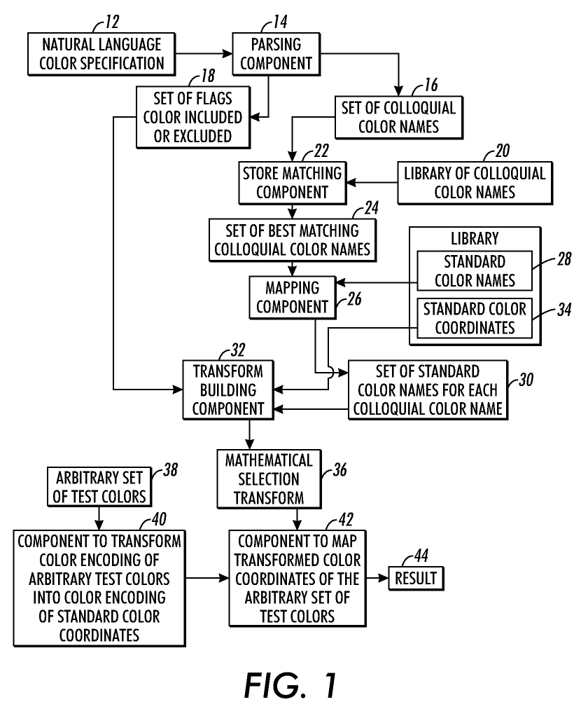

FIG. 1 illustrates an exemplary color description and selection system in accordance with the present invention.

With reference to FIG. 1, the functions of the components of the color selection method of the present invention are illustrated in a general block diagram form. As shown, block 12 represents a typical natural language color description or specification, for example, ‘reds and greens, but not dark greens’. This is explained in detail in the Component 1 description. The color descriptions or specifications in block 12 are separated by parsing component, block 14, into a set of colloquial color names, block 16 and a set of flags (indicators), block 18 that indicate whether a color name is to be included or excluded from the color selection.

As explained in Component 2, the colloquial color names in block 16 are compared with the set of colloquial names in a library of colloquial color names, block 20, as illustrated by block 22, to provide a set of best matching colloquial color names, as shown in block 24. This is the string matching component. A mapping component, component 3, as illustrated in block 26, maps each matching colloquial color name identified in block 16 to one or more standard color names in the library of standard colors, block 28, to provide a set of standard color names for each colloquial color name as shown at block 30.

The transform building component, component 4, illustrated in block 32, uses the standard color names from block 30 (component 3), and their standard color or numerical coordinates, as shown at block 34, together with the flags from component 1, shown at block 18, to create a mathematical selection transform, illustrated at block 36, typically in the form of a multi-dimensional lookup table.

In some instances, the encoding of the numerical coordinates of the standard colors in the library of standard colors is not the same as the encoding of the mathematical selection transforms provided by the selection transform builder, block 32. It may be necessary, therefore, to perform a conversion of the encoding of the numerical coordinates of the standard colors in the library of standard colors to the same encoding as the encoding of the mathematical selection transforms. This is provided by component 5, to transform an arbitrary set of test color coordinates, shown at block 38, into a color encoding identical to that used for the standard colors referenced in components 3 and 4, illustrated at block 40.

Component 6, shown at block 42 maps the selected matched color coordinates in the selection transform code through the selection transforms created by component 4 to produce a result, block 44, that indicates which of the test colors are in the selection or the probability that each of the test colors is in the selection.

In more detail, component 1 parses a natural language color specification by operating on a natural language phrase that specifies a color selection and providing two items. The first item is a list of the color names used in the phrase and the second is a set of flags—one flag for each identified color name—to indicate whether the corresponding color name is to be included or omitted from the color selection. For example if the phrase was “All greens and light reds except dark greens”, the returned list of color names would be {“greens”, “light reds” and “dark greens”} and the returned flags would be {+1, +1, −1} where +1 indicates the color is to be included in the selection and −1 indicates that the color is to be omitted from the selection.

In one embodiment, the component performs the following operations to parse the phrase:
a. The phrase is received by the component in the form of a string of arbitrary length.
b. Certain modifications are made to the string to simplify the parsing operation. These modifications might typically include:
   i. Convert the string to lower case
   ii. Replace occurrences of the word “except” with the words “and not”
   iii. Replace occurrences of the word “but” with “and”
   iv. Replace occurrences of <comma> with the characters “<space> and<space>”
   v. Eliminate instances of the words “colors”, “colours”, “colour” and “color”.
c. The resulting string is broken into a set of tokens. The tokens are the words in the string that are separated by white space. The tokens are numbered from 1 to n where n is the total number of tokens in the string.
d. The tokens are examined to find any that contain the word “not”. The indices (token numbers) of the “not” tokens are returned as a list (called IdxNot in this embodiment).
e. The tokens are examined to find any that contain the word “and”. The indices (token numbers) of the “and” tokens are returned as a list (called IdxAnd in this embodiment). Note that IdxNot and IdxAnd are mutually exclusive lists containing numbers that lie in the range from 1 to n.
f. Create a combined list (called IdxConjunction, representing conjunctions, in this embodiment) consisting of the union of IdxAnd and IdxNot.
g. Identify all those tokens that have token number not in the list of IdxConjunction as being tokens that are components of color names. Contiguous blocks of tokens between the IdxConjunction tokens represent entire (possibly multi-word) color names. Assemble the color names into a list. Assemble a list of flags, initially all set to +1 (indicating the color name is to be included in the selection), equal in length to the list of color names.
h. For each color name identified in step g examine any tokens that are members of IdxConjunction that immediately precede the color name. The words “immediately precede” mean tokens that are earlier in the string than the target color name, but after any preceding color names. If any of the preceding tokens is a member of IdxNot then set the corresponding flag to −1 (indicating the color name is to be excluded from the selection) in the list of flags.

Component 2 operates on two lists of color names—the target list returned from component 1 above and a library of common or colloquial color names. There is no restriction on the library of common color names other than it should encompass all or the vast majority of common color names that are used in the language. Both the target list and the common color name library may consist of multi-word color names. This component finds, for each color name in the target list, the best matching entry in the common color name library. It returns a list of indices into the common color name library—one index for each color name in the target list. It can optionally return the best matching name in the common color name library and a measure of distance between the target list color name and the best match in the common color name library.

In one embodiment, the component performs the following operations:
a. Convert both the target list and the common color names to lower (or upper) case so the algorithm is case insensitive.
b. For each color name in the target list compute the string edit distance to each of the entries in the common color name library. The string edit distance is defined as the minimum number of single-character edit operations (deletions, insertions, and/or replacements) that would convert the target color name into the common color name.
c. Find the minimum value of all the string edits distances computed in step b. If the minimum is zero then one of the common color names is an exact match to the target color name. Return the index of the matching common color name as well as any optional return values (e.g., matching name and edit distance).
d. If the minimum value of all the string edits distances computed in step b is greater than 0 then an exact match to the target name does not exist in the common color name library. This most often occurs due to spelling errors but can also arise if an unknown color name is used. If the target color name is a multi word name then search the library of common color names to find all entries for which at least one word in the target color name is a perfect match to a word in the common color name. Using this subset of the common color name library, find the common color name with the smallest string edit distance from the target color name. Return the index of the matching common color name as well as any optional return values (e.g., matching name and edit distance).

Component 3 provides a lookup from a common color name to one or more standardized color names. The common color name library is an exhaustive list of color names that are likely to be used in everyday language. It will often contain redundancies—also called synonyms—which are different color names used to describe the same basic color. For example, the common color names “light orange-brown” and “tan” are essentially different names for the same color definition. The standardized color names, on the other hand, have no redundancies and they are spaced so as to provide complete coverage of the perceptual color space and to provide differentiation between colors that matches or exceeds the differentiation possible using only language. Typically the list of standard color names is much smaller than the library of common color names. A typical example of a list of common color names is the NBS-ISCC standardized color names. Other standard color name systems that could be used might be a subset of the Munsell color names or the Web-safe colors.

The common color name library, in addition to its list of common color names, also includes, for each common color name, a list of one or more numbers that are indices (or pointers) into the standard color name list. Multiple common names can point to the same standard name. For example, both common names “baby blue” and “powder blue” might point to the same standard name of “pale cyan-blue”. Furthermore, a single common name can point to multiple standard color names. For example, the common name “green” might points to standard names {“light green”, “dark green”, “moderate green”, “pale green”, . . . }.

The standard color name list, in addition to the names, also contains the color coordinates of the prototypical color of the name. In order to provide an accurate mapping of names to color space coordinates it is important that the color coordinates be encoded in a reasonably perceptually uniform color space. Examples of such color spaces might include CIELab or CIELuv, but other spaces, such as color appearance spaces could be used. Even RGB spaces that are approximately perceptually uniform might be used.

For each target common color name in the list returned by component 2, component 3 performs a lookup of the indices into the standard color names list. It returns both the indices and the color coordinates of the standard color names. In addition this component takes the list of flags from component 1. It uses the flags to and the standard color names indices to create two lists of standard color name indices—one list of standard color name indices that are included in the selection (IdxStdinc) and a second list of standard color name indices that are to be specifically excluded from the selection (IdxStdExc).

Component 4 is the transform building component that takes the two lists of standard color name indices from component 3 and uses them to create a mathematical transform to perform the color selection operation on any set of arbitrary input colors. Note that the mathematical transform is generally designed to work on color data that is encoded using the same system used to encode the color coordinates of the prototypical colors of the standard color list. Typically these will be encoded in a reasonably perceptually uniform color space such as CIELab or CIELuv. The color encoding used is referred to henceforth as the “transform color encoding”. The function of the mathematical transform is to determine whether any arbitrary input colors is sufficiently close to one of the standard colors included in the selection (i.e., those having indices which appear in the list IdxStdinc but do not appear in the list IdxStdExc).

In one embodiment, the component builds a multi-dimensional lookup table using the following steps:
a. Create a set of samples representing all color that can be defined in the transform color encoding. If the transform color encoding has D dimensions then the samples will be defined on a D-dimensional grid. It is not necessary that the samples have uniform spacing, although it can be advantageous. For example, if the transform color encoding is CIELab, then D=3 corresponding to dimensions of L*, a* and b*.
b. Use the indices and color coordinates (in the transform color encoding) of the standard color name list to construct a kd-tree. In computer science, a kd-tree (short for k-dimensional tree) is a space-partitioning data structure for organizing points in a k-dimensional space. kd-trees are a useful data structure for several applications, such as searches involving a multidimensional search key (e.g., range searches and nearest neighbor searches).
c. Map each point in the sample grid created in step a, through the kd-tree created in step b to determine the closest standard color to each sample grid color.
d. Create a mapping grid of D-dimensions containing exactly the same number of grid points as were created in the sample color grid created in step a. The mapping grid point is set to 1 if the corresponding sample color has a nearest neighbor standard color that has an index in the list IdxStdinc. Otherwise, or if the nearest neighbor standard color has an index in the list IdxStdExc, set the mapping grid point to 0. The mapping grid is now a D-dimensional grid with grid points relating to each of the sample colors created in step a, but with a value equal to 1 if the sample color is in the color selection and 0 if the outside the color selection.
e. Optionally, in the interest of creating a well-behaved, smooth selection transform, the mapping grid created in step d can be smoothed (i.e. sharp edges softened) by convolving it with a D-dimensional Gaussian (or similar) blurring filter.

At the end of these steps a mapping grid has been created. The mapping grid acts as a color selector when it is used as a multi-dimensional lookup table in component 6.

Component 5 is a color transforming component. In order to use the color selector created in component 4 with any arbitrary set of test colors, it is necessary that the test colors be encoded in the transform color encoding. Accordingly component 5 provides a mechanism to convert color coordinates in any arbitrary color encoding to the transform color encoding. This is a standard color management operation and can be accomplished using ICC color management profiles and a standard color management engine.

Component 6 is the component to apply the color selection transform to test colors. This component takes the set of test color coordinates, encoded in the transform color encoding, created in component 5 and maps them through the mathematical selection transform created in component 4. In one embodiment, the mathematical selection transform is a multi-dimensional lookup table and this component performs interpolation of the mathematical selection transform to obtain an output value for each of the test color coordinates. Typical interpolation methods are well know by those skilled in the art and could include multi-linear interpolation (trilinear interpolation for a 3 dimensional LUT) or interpolation using D-dimensional simplices having D+1 faces (tetrahedral interpolation for a 3 dimensional LUT). In the embodiment described in this disclosure, the interpolation returns values between 0 and 1 for each of the test colors. This value can be interpreted as the probability that the test color is in the selection.

Although the present invention has been described with reference to particular embodiments, it should be recognized that these embodiments are merely illustrative of the principles of the present invention and that the scope of the present invention is broadly applicable as defined in the attached claims.

What is claimed is:

1. In a system having a library of colloquial color names and a library: of standard colors, a method of color selection comprising the steps of:
parsing a natural language color specification into a set of colloquial color names and a set of flags,
providing a best match of the set of colloquial color names in the color specification to the library of colloquial color names,
mapping the best match of the set of colloquial color names to a set of standard colors in the library of standard colors, and
responding to the set of standard colors and the flags of the natural language color specification to create mathematical selection transforms.

2. The method of claim 1 including the step of mapping the set of standard colors through the mathematical selection transforms to produce a result that indicates that the standard colors are in the color selection.

3. The method of claim 1 including the step of mapping the set of standard colors through the mathematical selection transforms to produce a result that indicates the probability that each of the test standard colors is in the color selection.

4. The method of claim 1 wherein the standard colors have color encodings different from the encodings of the mathematical selection transforms and including the step of transforming the standard colors into a color encoding similar to the color coding of the mathematical selection transforms.

5. The method of claim 4 including the steps of mapping the standard color encodings through the mathematical selection transforms to produce a result that indicates that the standard colors are in the color selection and mapping the standard color encodings through the mathematical selection transforms to produce a result that indicates the probability that each of the test colors is in the color selection.

6. The method of claim 1 wherein a flag is provided for each colloquial name to indicate the inclusion or exclusion of the colloquial name in the color selection.

7. The method of claim 1 wherein the library of colloquial color names includes multi word color names.

8. The method of claim 1 wherein the library of colloquial color names includes color redundancies.

9 The method of claim 1 wherein the step of responding to the set of standard colors and the flags of the natural language color specification to create a mathematical selection transform includes the step of providing a mapping grid for color selecting.

10. The method of claim 9 wherein the mapping grid is a multi-dimensional lookup table.

11. In a system for providing color images, a method for color selection based upon perceptual color boundaries between colors including the steps of:
providing a color selection using a perceptual description,
separating from the perceptual description a set of common color names, matching the color names to a best match color in a library of color names, and
mapping each best match color to a standard color in a library of standard colors.

12. The method of claim 11 wherein the perceptual description includes a set of flags, the flags indicating an inclusion or exclusion of the color name from the color selection.

13. The method of claim 11 including the step of using the standard color to provide a mathematical selection transform.

14. The method of claim 13 wherein the mathematical selection transform is encoded in a specific code and the standard color includes numerical coordinates, including the step of transforming the numerical coordinates of the standard color into a color encoding similar to the specific code of the mathematical selection transform.

15. A method of color selection including the steps of:
parsing a natural language color specification into a set of colloquial color names and a set of flags,
finding the best matching colloquial color name in a library of colloquial color names for said set of colloquial color names,
mapping each matching colloquial color name identified to one or more standard colors in a library of standard colors,
responding to the standard colors and the set of flags to create a mathematical selection transform, and
mapping the standard colors through the selection transform for determining the standard colors that are in the color selection.

16. The method of claim 14 including the step of determining the probability of the standard colors being in the color selection.
